(19) United States
(12) Patent Application Publication
(10) Pub. No.: US 2004/0233152 A1
(43) Pub. Date: Nov. 25, 2004

(54) Operating device and method for partial display mode monitor

(75) Inventors: Ching-Tung Wang, Hsinchu Hsien (TW); Yu-Yun Hsu, Hsinchu (TW); Yung-Sheng Hsu, Junan Jen (TW)

Correspondence Address: LIU & LIU LLP, 811 WEST SEVENTH STREET, SUITE 1100, LOS ANGELES, CA, 90017, US

(73) Assignee: Toppoly Optoelectronics Corp.

(21) Appl. No.: 10/850,945

(22) Filed: May 21, 2004

(30) Foreign Application Priority Data
May 22, 2003 (TW) 92113812

(51) Int. Cl. G09G 3/36

(52) U.S. Cl. 345/98

(57) ABSTRACT

An method for the partial display mode monitor, which is suitable for the monitor operation in the partial mode. In this method, the memory is first planned so that each pixel has one corresponding memory address in a plurality of memory addresses within the planned memory. A serial controller is used to detect and determine whether the original pattern in the display screen has been updated or not, wherein the original pattern is stored in the memory and also comprises some pixels which have corresponding memory addresses. Then, when the serial controller detects that the original pattern has updated to a new pattern, the new pattern is compared with the original pattern, so as to replace the original pattern, which is stored in the memory and its corresponding memory addresses, with the new pattern. Finally, the new pattern is output to the monitor.

### CROSS-REFERENCE TO RELATED APPLICATION

This application claims the priority benefit of Taiwan application serial no. 92113812, filed on May 22, 2003.

### BACKGROUND OF THE INVENTION

1. Field of Invention

The present invention relates to a monitor, and more particularly, to a method for operating a partial display mode monitor.

2. Description of Related Art

The liquid crystal display (LCD) is widely used nowadays in daily life. In various portable electronic products, since the power storage capacity of the battery is limited, the power saving design has been an important aspect during its development. Therefore, the power saving capability of the LCD related module has also become one of the major issues in its development. Commonly, in prior art, the electronic product is set to enter into the partial mode as a power saving design for the LCD related module. During the operation of the partial mode, the driving circuit of the LCD is used to continuously update patterned digital screen data, such as images representing date, time, and power storage indication, etc. Since the patterned digital screen data is stored in the memory of the integrated circuit (IC), the electronic apparatus does not need to install an additional related circuit. Consequently, power consumption is reduced. However, since the partial mode operation in the prior art updates all of the patterned digital screen data patterns in the screen, the repeatedly updating of the unnecessary updated patterned digital screen data causes a waste of power consumption. Therefore, if this kind of the unnecessary power consumption is eliminated, the battery life can be prolonged.

### SUMMARY OF THE INVENTION

It is an object of the present invention to provide a method for operating the partial display mode monitor, which is suitable for the monitor operation in the partial mode. The method is able to avoid the power consumption caused by the repeatedly updating of the unnecessary updated patterned digital screen data in the partial mode.

The inventive monitor driving method and device group pixels into patterns (e.g., groups of pixels representing an icon or identifiable image), and updating those patterns of which corresponding original image data have been determined to being changed by new image data input. The present invention is applicable to “static” type images, such as icons representing battery power indicator, signal strength indicator, date, and other informational or status images, which may be updated from time to time as needed depending on a change in the underlying status or information represented by the image pattern.

In one embodiment, the present invention provides a method for operating the partial display mode monitor, which is suitable for the monitor operation in the partial mode. In the operating method, the memory is first planned so that the pixel data is stored in the corresponding memory address. A serial controller is used to detect and determine whether the original pattern in the display screen has been updated or not, wherein the original pattern is stored in the memory. Then, when the serial controller detects that the original pattern has updated to a new pattern, the new pattern is compared with the original pattern, so as to replace the original pattern, which is stored in the memory and its corresponding memory addresses, with the new pattern. Finally, the new pattern is output to the monitor.

In accordance with the embodiment of the present invention, the data controller in the driving circuit achieves comparing the new pattern with the original pattern. When the serial controller detects that the original pattern has updated to a new pattern, the new pattern is sent to the data controller via the timing controller and data latch in the driving circuit. Furthermore, after the data controller compares the new pattern with the original pattern and stores the new pattern in the corresponding memory addresses, the new pattern is sent to the monitor via the D/A controller.

In accordance with the present invention the method of operation in the partial display mode is able to avoid power consumption caused by the repeatedly updating of the unnecessary updated patterns in the partial mode, thus saving power. In addition, since the process of the operating circuit of the electronic apparatus is simplified, power consumption can be reduced.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic circuit block diagram of a LCD driving module in accordance with one embodiment of the present invention.

FIG. 2 is a diagram illustrating a LCD panel of an embodiment of the present invention.

FIG. 3 is a memory mapping diagram of an embodiment of the present invention.

FIG. 4 is a schematic diagram illustrating an electronic device that incorporates an LCD panel having the inventive driving module in accordance with one embodiment of the present invention.

FIG. 5 is a flow diagram illustrating the process involved in the method of driving an LCD panel in accordance with one embodiment of the present invention.

### DESCRIPTION OF THE PREFERRED EMBODIMENTS

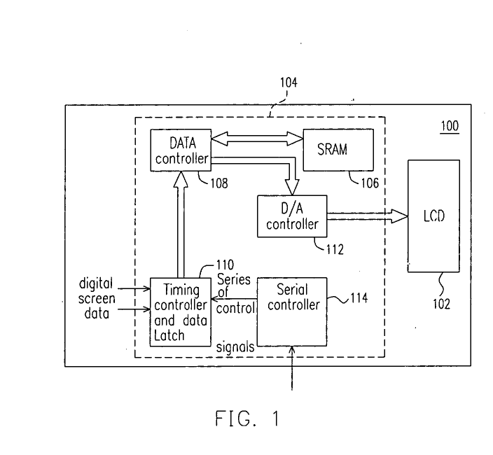

FIG. 1 is a schematic circuit block diagram of a LCD module. The LCD module 100 comprises a LCD 102 and a driving circuit 104 (which may be implemented as an ASIC, Application Specific Integrated Circuit). The driving circuit 104 comprises a memory 106, a data controller 108, a Timing controller and data latch 110, a D/A controller 112, and a serial control circuit 114. The LCD 102 is electrically coupled to the driving circuit 104.

In accordance with the method of the present invention, the digital screen data are fed into the timing controller and data latch 110 when the LCD 100 is normally operated. Then, the timing controller and data latch 110 outputs the digital screen data into the data controller 108, and the data controller 108 output the digital screen data into the D/A controller 112. Finally, the D/A controller 112 output the digital screen data into the LCD 102 so as to form a screen display.

After the partial mode is activated in display operation , the read/write operation is performed in the memory 106, since this operation is similar to the conventional partial mode operation mentioned above, its description is omitted herein.

Unlike the prior art systems involving repeatedly updating of the unnecessary updated patterns which causes an unnecessary waste of power while using the partial mode, the drive module 104 of the present invention prolongs battery life. The data controller 108 stores the screen data into the SRAM 106 according to a predetermined associated memory address, i.e. each pixel of the patterned digital screen data has one corresponding memory address in the memory 106. Under the partial mode, after a digital screen data of the display is input into the timing controller and data latch 110, the serial controller 114 uses to detect whether an original patterned digital screen data in the display screen has been updated or not. When a control signal from the serial controller 114 indicates that the original patterned digital screen data has updated to a new pattern, the new patterned digital screen data is sent to the data controller 108 via the timing controller and data latch 110 in the driving circuit 104. The data controller 108 then replaces the original patterned digital screen data stored in the memory 106 with the new patterned digital screen data. In addition, if the whole display screen needs to be updated, the serial controller 114 sends a set of control signals (a series of control signals) to the timing controller and data latch 110. Then, the timing controller and data latch 110 enters the series of control signals into the data controller 108, and the data controller 108 then writes the whole display screen data into the memory 106. On the other hand, if only part of the patterned digital screen data of the display screen needs to be updated, the data controller 108 writes the corresponding patterned digital screen data into the corresponding address of the memory 106. The corresponding patterned digital screen data is then output into the D/A controller 112 and then output to the LCD 102, and the rest is not updated.

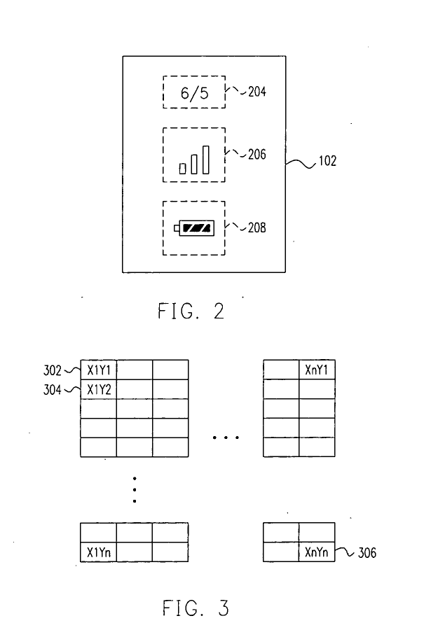

FIG. 2 is a diagram illustrating the display of a LCD panel in accordance with one embodiment of the present invention. It is assumed that the LCD 102 has a date pattern 204, a signal strength pattern 206, and a battery strength pattern 208 displayed on it, resembling the display of a typical cellular phone, for example. Referring also to FIG. 3, the schematic shows a memory mapping diagram of a preferred embodiment of the present invention. It is further assumed herein that the pixel data of the date pattern 204 is stored in the memory area 302 (X1Y1), the pixel data of the signal strength pattern 206 is stored in the memory area 304 (X1Y2), and the pixel data of the battery strength pattern 208 is stored in the memory area 306 (XnYn). Wherein, the memory areas 302, 304, and 306 are the memory areas set in advance. Under the partial mode, after the display screen data composed of the data pattern 204, the signal strength pattern 206, and the battery strength pattern 208 are input into the timing controller and data latch 110, the serial controller 114 uses a control signal to detect whether these three patterns have been updated or not. Then, if only the signal strength pattern 206 among these three patterns is changed, the data controller 108 only updates the data stored in the memory address 304, and does not update the data stored in the other memory addresses. Finally, the timing controller and data latch 110 displays the data stored in the memory 106 on the monitor 102 via D/A controller 114.

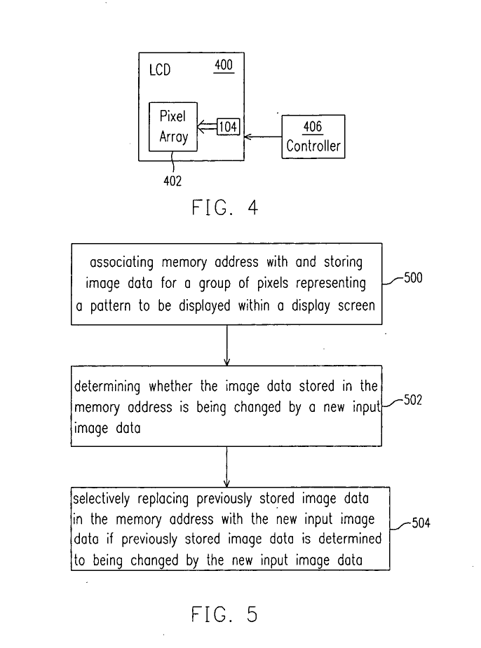

In general, the invention can be implement into an LCD as shown in FIG. 4. The LCD 400 includes a display device, such as the pixel array 402, for displaying the image of screen pattern. The pixels of the pixel array 402 to display the screen pattern are controlled by the driving circuit 104 as shown in FIG. 1. Further, the invention can be implemented in an electronic device, which includes the LCD 400 and a controller 406. The controller 406 inputs needed data and the needed control signal to the LCD 400.

FIG. 5 is a flow diagram illustrating the process involved in the method of driving an LCD panel in accordance with one embodiment of the present invention. In FIG. 5, the method for controlling a display device comprises the steps as follows.

In step 500, the memory address is associated with and storing image data for a group of pixels representing a pattern to be displayed within a display screen, said image data stored in the memory address can be output to the display device to render the pattern. In step 502, it is determined whether the image data stored in the memory address is being changed by a new input image data. In step 504, previously stored image data in the memory address is selectively replaced with the new input image data if previously stored image data is determined to being changed by the new input image data.

In summary, the present invention provides a device and method for operating the partial display mode monitor, which is suitable for the monitor operation in the partial mode. Since the new screen data is compared with the original screen data before the display screen is updated, the operating method of the present invention only updates the portion of the data that has changed. Therefore, the operating method is able to avoid power consumption caused by the repeatedly updating of the unnecessary updated patterns, and thus saving power.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for operating a monitor in a partial display mode, the monitor comprising a plurality of pixels, a driving circuit, the driving circuit comprising a memory, and the operating method comprising the following steps of:
assigning memory areas of the memory corresponding to each of the pixels;
detecting whether an original pattern in the monitor has updated or not, wherein a serial controller is used to detect; and
replacing the corresponding original pattern when the serial controller indicates that the original pattern has updated to a new pattern, which is stored in the memory and its corresponding memory addresses, with the new pattern, and outputting the new corresponding pattern to the monitor.

2. The method of claim 1, wherein the memory is a Static Random Access Memory (SRAM).

3. The method of claim 1, wherein when the serial controller detects the original pattern has updated to a new pattern, the new pattern is sent to a data controller via a timing controller and data latch in the driving circuit.

4. The method of claim 3, wherein after the data controller compares the new pattern with the original pattern and stores the new pattern in the corresponding memory addresses, the new corresponding pattern is sent to the monitor via a D/A controller.

5. A display control device for controlling a display device, comprising:
a memory address associated with and storing image data for a group of pixels representing a pattern to be displayed within a display screen, said image data stored in the memory address can be output to the display device to render the pattern;
a data controller determining whether the image data stored in the memory address is being changed by a new input image data, and selectively replacing previously stored image data in the memory address with the new input image data if previously stored image data is determined to being changed by the new input image data.

6. The display control device as in claim 5, wherein the data controller operates the display device in a partial display mode.

7. The display control device as in claim 5, where in the data controller comprises a Timing controller and data latch.

8. The display control device as in claim 5, wherein the data controller determines whether the previously stored image data is being changed by the new input image data by comparing the new input image data to the previously stored image data.

9. The display control device as in claim 5, further comprising a data output controller outputting the image data stored in the memory address.

10. The display control device as in claim 9, wherein the data output controller comprises a D/A controller.

11. The display control device as in claim 8, further comprising a plurality of memory addresses, each associated with and storing image data for a group of pixels representing a different pattern to be displayed within a display screen, said stored image data can be output to the display device to render the different pattern.

12. The display control device as in claim 11, wherein the data controller determines for each different pattern whether the image data stored in the associated memory address is being changed by a new input image data, and selectively replaces previously stored image data in the memory address with the new input image data, for those patterns of which previously stored image data is determined to being changed by the new input image data.

13. A display, comprising:
a display device; and
a display control device for controlling the display device as in claim 5.

14. An electronic device, comprising:
a display as in claim 13; and
a controller providing input image data to the display.

15. A method for controlling a display device, comprising the steps of:
associating memory address with and storing image data for a group of pixels representing a pattern to be displayed within a display screen, said image data stored in the memory address can be output to the display device to render the pattern;
determining whether the image data stored in the memory address is being changed by a new input image data; and
selectively replacing previously stored image data in the memory address with the new input image data if previously stored image data is determined to being changed by the new input image data.
